(19) United States
(12) Patent Application Publication
(10) Pub. No.: US 2008/0310173 A1
(43) Pub. Date: Dec. 18, 2008

(54) CANDLE COVER APPARATUS

(76) Inventor: Charles Craven, Malibu, CA (US)

Correspondence Address: CHRISTIE, PARKER & HALE, LLP, PO BOX 7068, PASADENA, CA, 91109-7068, US

(21) Appl. No.: 11/764,714

(22) Filed: Jun. 18, 2007

(51) Int. Cl. F21V 21/14

(52) U.S. Cl. 362/393

(57) ABSTRACT

A candle cover apparatus for lighting fixtures, comprising a candle cover adapted to be secured to medium base lighting fixture sockets, a decorative means, extender pieces of different heights attachable to the bottom end of the candle cover, and an altering means to alter the inner dimension of the cover in order to secure the cover to candelabra base lighting fixture sockets. The decorative means comprises a slip-on collar comprising a faux wax drip pattern and/or a figurine formed as part of the cover or detachably secured to the cover.

### CROSS-REFERENCE TO RELATED APPLICATION

None

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to candle apparatuses, and more particularly to a candle cover apparatus that can be used with conventional medium and candelabra base lighting fixture sockets.

Several candle apparatuses have been developed in the art. For example, U.S. Pat. No. 4,693,681 to Comstock discloses a candle apparatus for providing a candle-like flame and candle effect. The apparatus employs a liquid and a wick for generating flame; the wick being soaked in the liquid which is combustible. The apparatus comprises a base member having a base opening and a canister for the liquid. A shell extends over the base and canister. The shell is easily removable and also interacts with the canister so as to support it in proper position. However, the candle apparatus is not designed for use with electrical fixtures.

U.S. Pat. No. 4,590,545 to Scheer discloses a lighting fixture simulating a candle holder. The fixture comprises a bobeche and candle cup, which are to be interchangeably used by affixing and removing over an electrical socket. More particularly, a connecting flange mounted immediately adjacent to the electric socket support has an external threaded portion to which the bobeche or the candle cup is engaged; the diameter of the external threaded portion being larger than that of the socket. However, the lighting fixture does not employ any candle covers.

U.S. Pub. No. 20060028828 to Phillips discloses a candle cover for use with a light fixture comprising at least one candle assembly. The at least one candle assembly is adapted to carry a light bulb having an attachment base, such as a screw shell. The candle cover comprises a longitudinal, translucent sleeve, through which, the candle assembly is received. The attachment base lies slightly below a top surface of the candle cover as the assembly is received within the candle cover so as to give a distinctive glowing appearance to the candle cover. However, the size of the candle cover is not adjustable as in the present invention.

Typically, candle covers are only adapted to be secured either on a medium base socket or a candelabra base socket. A user thus needs to use candle covers of two different sizes, which increases expenses as the user is required to purchase two sets of candle covers.

It is therefore an object of the present invention to provide a candle cover apparatus that is adapted to be secured to both medium and candelabra base sockets.

A further object is to provide a candle cover apparatus that includes means to increase the height of the cover.

A further object is to provide a candle cover apparatus that includes decorative features. These and other objects of the present invention will become better understood with reference to the appended Summary, Description, and Claims.

### SUMMARY

The present invention is a decorative candle cover apparatus that can be used with both medium and candelabra base light fixture sockets. The apparatus comprises a candle cover, a plug adapted to be secured inside the cover, extender pieces for increasing the height of the cover and decorative means such as a slip-on faux wax dip collar and/or a figurine. The plug includes a hole at its center. The cover without the plug can be secured over the medium base socket. The cover with the plug is used for the candelabra socket, with the socket passing through the hole. The figure can be detachable or formed as part of the cover.

### BRIEF DESCRIPTION OF THE FIGURES

FIG. 1 is a sectional view of the candle cover apparatus with plugs in accordance with the present invention.

FIG. 2 is a sectional view of the candle cover apparatus without plugs.

FIG. 3 is a front view of the apparatus with the slip-on collar.

FIG. 4 is a perspective view of the plug.

FIGS. 5 and 6 are front views of the apparatus with figurines formed as part of the cover.

FIG. 7 is a front view of apparatus with a figurine anchored to the top end of the cover.

FIGS. 8, 9 and 10 are front views of the apparatus with figurines detachably secured to the cover.

FIGS. 11 and 12 are front views of FIG. 5 with extender pieces attached to the bottom end of the cover, the figurine being a part of the cover and the extender pieces.

FIGS. 13 and 14 are front views of FIG. 6 with plain extender pieces attached to the bottom end of the cover.

FIGS. 15 and 16 are front views of FIG. 7 with plain extender pieces attached to the bottom end of the cover.

### FIGURES—REFERENCE NUMERALS

10 . . . Candle Cover Apparatus
12 . . . Candle Cover
14 . . . Collar
16 . . . Plug
18 . . . Hole
20 . . . Figurine
22 . . . Extender Piece

### DETAILED DESCRIPTION

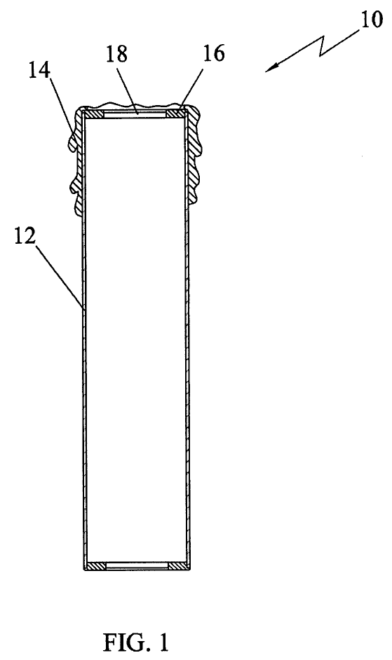

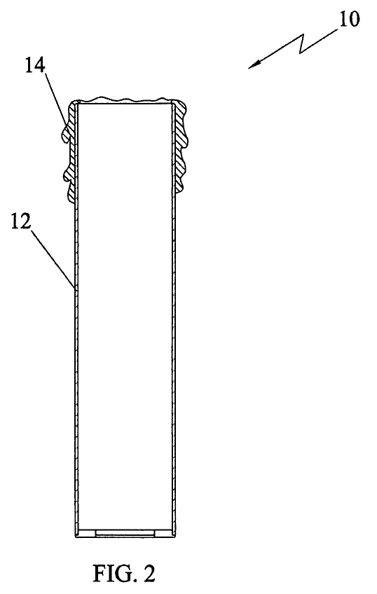

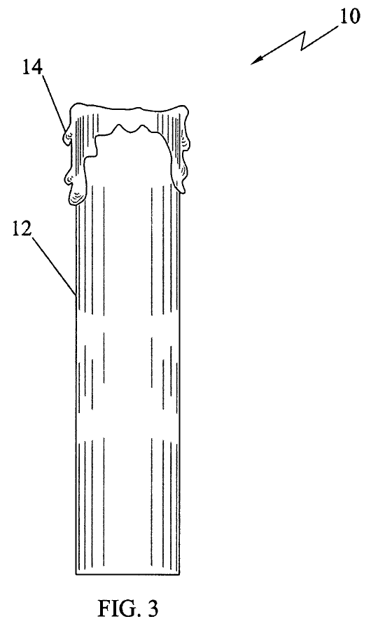

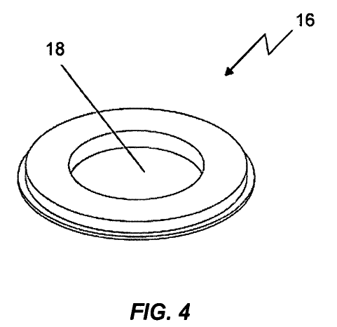

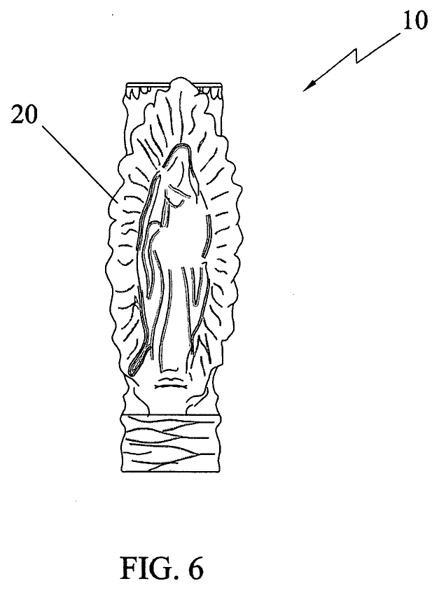

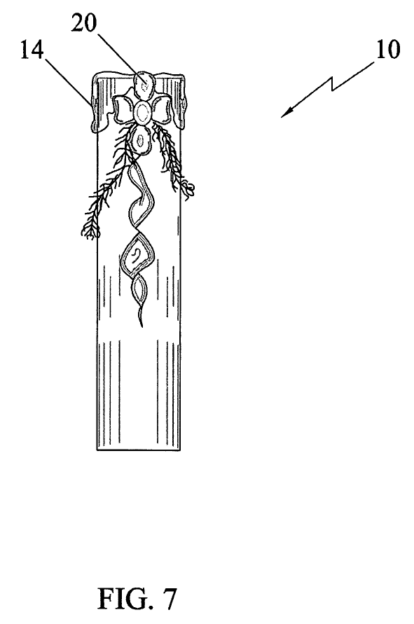

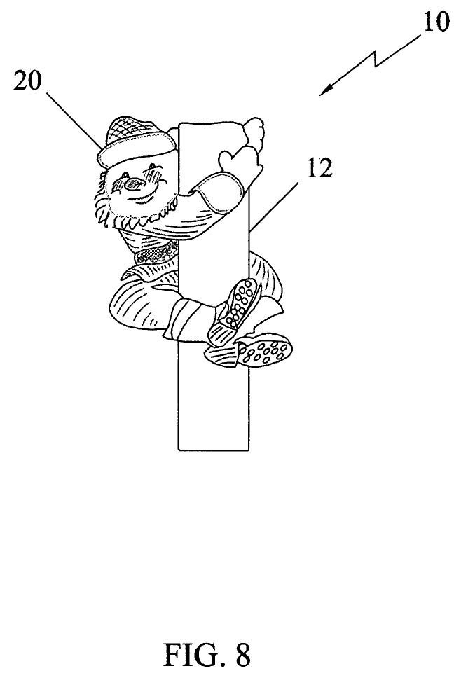

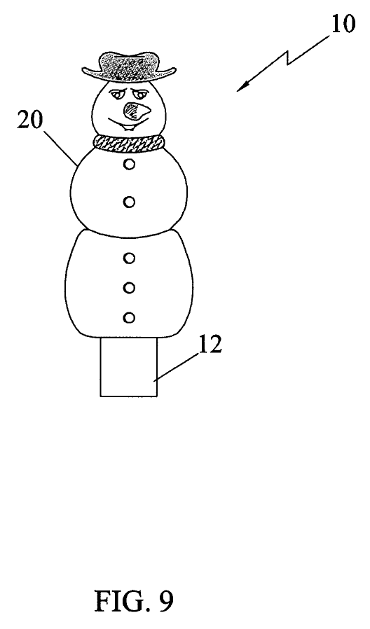

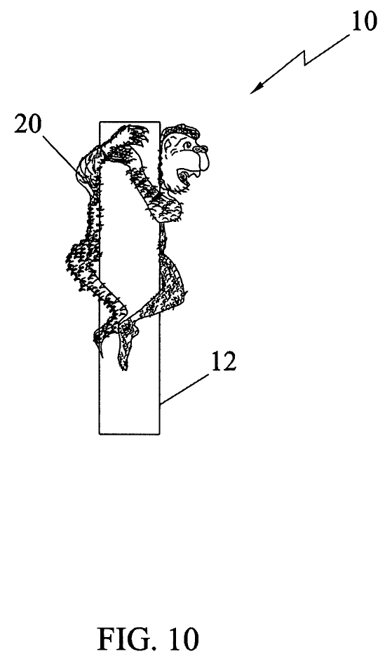

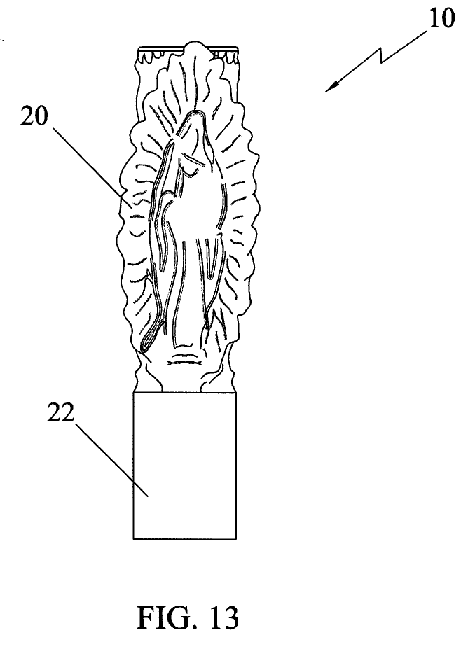

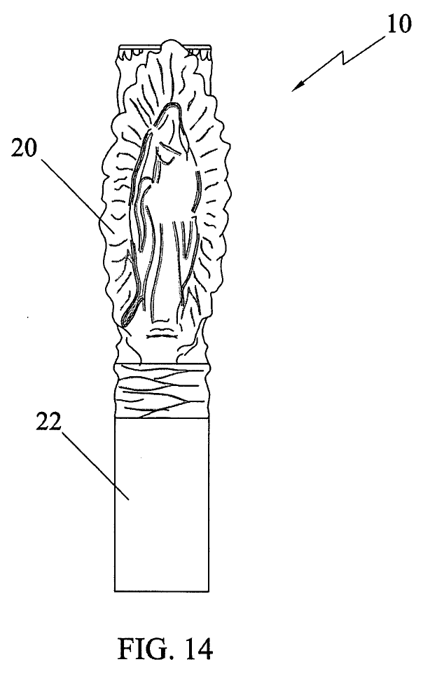

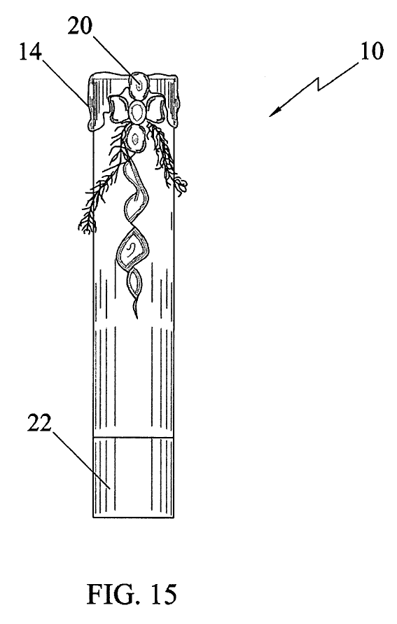

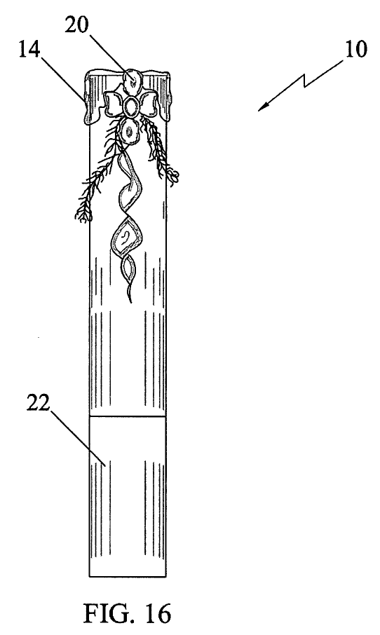

Referring to the drawings, a preferred embodiment of the candle cover apparatus for lighting fixtures is illustrated in FIGS. 1 through 16. The apparatus 10 is mainly designed to he used with medium and candelabra sockets.

Referring to FIGS. 1 through 4, the apparatus 10 mainly comprises a candle cover 12 of cylindrical sleeve-like configuration, a slip-on collar 14 with faux wax dip pattern, and a plug 16. The collar 14 is slipped over the top end of the cover. The cover 12 without the plug 16 is dimensioned to secure over a medium socket. The plug 16 securely fits inside the cover 12 and includes a hole 18 at its center that is dimensioned to securely receive a candelabra socket. In order to secure the apparatus 10 to a candelabra socket, the plug 16 is inserted in the bottom end of the cover and the candelabra socket is securely received in the hole 18 of the plug. The apparatus can thus be used with medium and candelabra sockets.

The plugs 16 can also be secured inside the top end of the cover. The collar 14 is slipped on to the top end of the cover 12.

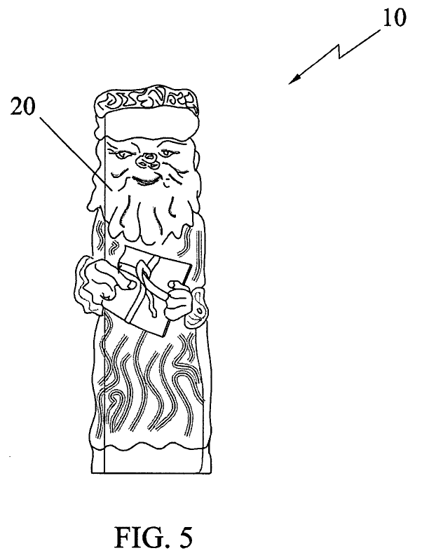

Referring to FIGS. 5 through 10, in alternate embodiments, the apparatus comprises decorative means instead of or in addition to the collar. The decorative means can comprise a figurine 20. The figurine 20 can surround all or a portion of the candle cover 12. The figurine can be formed as part of the candle cover. Alternatively, the figurine 20 can be detachably secured and slipped over the cover or anchored to the top end of the cover 12.

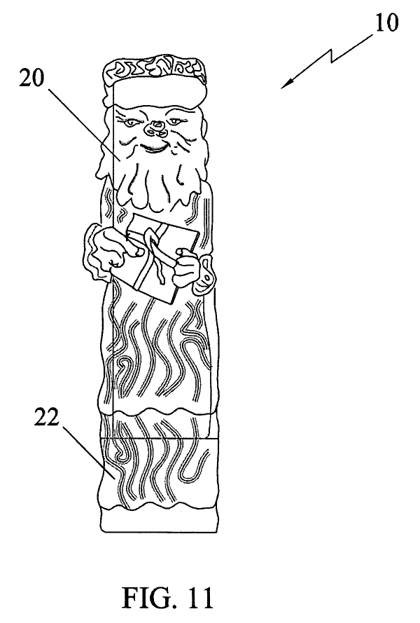

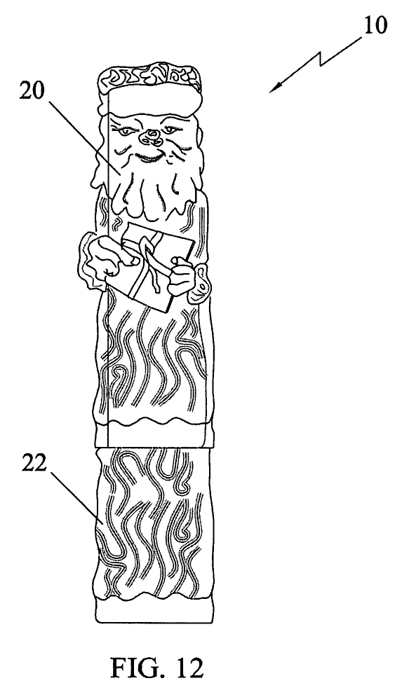

Referring to FIGS. 11 through 16, the apparatus further includes extender pieces 22 for increasing the height of the cover 12. These extender pieces 22 are of different heights and are attached to the bottom ends of the covers. The extender pieces 22 are also of cylindrical sleeve-like configuration and can be plain with no designs. Alternatively, the figurine can be formed as part of both the candle cover and the extender pieces, as in FIGS. 11 and 12.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A candle cover apparatus for lighting fixtures, comprising:
(a) a cover adapted to be secured to a first lighting fixture socket;
(b) a height adjusting means for altering the height of the apparatus; and
(c) a securing means to secure the apparatus to lighting fixture sockets of sizes different from the size of the first lighting fixture socket to which the candle cover is adapted to be secured.

2. The apparatus of claim 1, wherein the cover is to be secured over the first socket, and the securing means comprises an altering means to alter the inner dimension of the cover in order to secure the cover to sockets that are smaller than the first socket.

3. The apparatus of claim 2, wherein the candle cover is adapted to be secured to a medium socket without employing the altering means and to a candelabra socket by employing the altering means.

4. The apparatus of claim 2, wherein the altering means comprises at least one internal plug having a hole at its center, the at least one plug is adapted to securely fit inside the cover apparatus and the hole is dimensioned to make the plug securely fit over a socket that is smaller than the first socket.

5. The apparatus of claim 4, wherein the plug is secured inside the bottom end of the cover.

6. The apparatus of claim 4, wherein the plug is secured inside the top and bottom ends of the cover.

7. The apparatus of claim 1, wherein the height adjusting means comprise extender pieces of different heights attachable to the ends of the cover.

8. The apparatus of claim 7, wherein the extender piece is adapted to be secured over a first socket, and the securing means comprises an altering means to alter the inner dimension of the extender piece in order to secure the extender piece to sockets that are smaller than the first socket.

9. The apparatus of claim 8, wherein the altering means comprises at least one internal plug having a hole at its center, the plug is adapted to securely fit inside the cover or the extender pieces and the hole is dimensioned to securely fit over a socket that is smaller than the first socket.

10. The apparatus of claim 7, wherein the cover and extender pieces are of cylindrical sleeve-like configuration.

11. The apparatus of claim 1 further includes a decorative article detachably secured to the cover.

12. The apparatus of claim 11, wherein decorative article comprises a slip-on collar comprising a faux wax drip pattern.

13. A candle cover apparatus for lighting fixtures, comprising:
a cover adapted to be secured to a first lighting fixture socket;
a decorative means;
a height adjusting means for altering the height of the apparatus; and
an altering means to alter the inner dimension of the cover in order to secure the cover to sockets that are smaller than the first socket.

14. The apparatus of claim 13, wherein the height adjusting means comprise extender pieces of different heights attachable to the bottom end of the cover.

15. The apparatus of claim 14, wherein the altering means comprises at least one internal plug having a hole at its center, the plug is adapted to securely fit inside the cover or the extender pieces and the hole is dimensioned to securely fit over a socket that is smaller than the first socket.

16. The apparatus of claim 13, wherein the decorative means comprises a figurine.

17. The apparatus of claim 16, wherein the figurine is formed as part of the cover.

18. The apparatus of claim 16, wherein the figurine is formed as part of the cover and the height adjusting means.

19. The apparatus of claim 16, wherein the figurine surrounds all or a portion of the cover.

20. The apparatus of claim 16, wherein the figurine is detachably secured to the cover.

21. The apparatus of claim 16, wherein the figurine is anchored to the top end of the cover.

22. The apparatus of claim 16, wherein the figurine is slipped over the cover.
